(19) United States
(12) Patent Application Publication
(10) Pub. No.: US 2003/0065792 A1
(43) Pub. Date: Apr. 3, 2003

(54) Securing information in a design collaboration and trading partner environment

(76) Inventor: Gregory Scott Clark, Hillsborough, CA (US)

Correspondence Address: SWERNOFSKY LAW GROUP PC, P.O. BOX 390013, MOUNTAIN VIEW, CA, 94039-0013, US

(21) Appl. No.: 09/967,907

(22) Filed: Sep. 28, 2001

(51) Int. Cl. G06F 15/16

(52) U.S. Cl. 709/229

(57) ABSTRACT

The invention provides a method and system for providing distributed, secure access to sensitive information. An owner of a data object causes the object to be placed at a secure location logically remote to the owner. The object resides in an electronic vault which itself resides in a protected workspace. A trading partner may be given access to both the workspace and the vault through a decentralized authentication process using an access control entity. Upon determining that the trading partner should be given access to the object, the access control entity provides the trading partner access to the vault and the object. At the discretion of the object owner, attempting to access the object may trigger a Nondisclosure Agreement or other administrative task to be completed prior to granting access to the object. Data relating to access and attempts to access protected objects are recorded in a computerized log.

Related Art

To succeed in the competitive world market, it is commonly accepted that business must forge trading relationships with partners. Relationships of these types rely and thrive on highly fluid methods of communication. Often it is desirable for one organization to grant another access to sensitive information. This information might include current research and development, intellectual property, or other confidential business information that the source does not desire to release for public dissemination.

Policing access to sensitive information can be logistically cumbersome, and in a networking environment, technically complex. Many business enterprises are reluctant to give up control of their sensitive information to third parties. However, sharing sensitive information often requires the cooperation of both the recipients of that information, and third party authenticators of those recipients.

A first known method for negotiating access to sensitive information by an outside entity is to meet with that entity personally, and to deliver the information after assuring that the entity is trustworthy. While this method achieves the general goal of assuring that recipients are trustworthy (possibly after executing appropriate legally-binding agreements) it has the important drawback that both parties be personally and actively present in the authentication and trust-assuring process; thus, time and effort are required from individuals associated with both organizations. This can be expensive and inconvenient.

A second known method for negotiating access to sensitive information by an outside entity is to exchange documents sufficient to assure the trustworthiness of that entity, and to deliver the information after assuring that the entity is trustworthy. Documents of this nature might be exchanged by courier or by mail. While this method achieves the general goal of assuring that recipients are trustworthy (possibly after executing appropriate legally-binding agreements) it has the same important drawback that in-person authentication has, namely, that both parties be personally and actively present in the authentication and trust-assuring process; thus, time and effort are required from individuals associated with both organizations. This can be expensive and inconvenient. Moreover, this method has the drawback that exchanging documents, both for sending and receiving them, and for reviewing them, can take substantial time. Businesses might be loath to expend the amount of time required for full authentication, due to the adverse effect on the time to conduct business, but might be equally loath to allow a quicker and less sure form of authentication.

There are additional other problems with exchanging documents. (1) The sending and receipt of documents, and of sensitive information itself, has a degree of uncertainty which is undesirable. (2) When documents are exchanged electronically or using a communication network, the likelihood of being able to legally enforce any agreements is reduced.

Accordingly, it would be advantageous to provide a technique for allowing information to be exchanged in a secure environment, while being able to assure trustworthiness of the recipient, and while meeting any desirable administrative and legal requirements.

### SUMMARY OF THE INVENTION

The invention provides a method and system for secure distribution of information, such as in a design collaboration and trading partner environment. An owner of a data object or document causes the object to be placed at a location logically remote to the owner, but associated with an autonomous access control entity for the data object or document. The object resides in an electronic vault which itself resides in a protected electronic workspace. A trading partner, having been authorized to obtain access to the electronic workspace, requests access to the protected data object or document; that trading partner must separately obtain authorization from the access control entity to access the data object or document.

Upon determining that the trading partner should be given access to the object, the access control entity provides the trading partner access to the associated data object or document. As part of securing access to the data object or document, the trading partner may be prompted (and required by the access control entity) to sign a nondisclosure agreement, such as electronically by using a digital signature or physically with a hard copy of the nondisclosure agreement. If electronically, the nondisclosure agreement can be routed to others if the individual at the trading partner lacks authority to sign the nondisclosure agreement.

Once the nondisclosure agreement is signed, the data object or document is released to the trading partner. A log records all access activity to an object and the protected areas that surround it.

### BRIEF DESCRIPTION OF THE DRAWINGS

FIG. 1 shows a block diagram of a system capable of securing information in a design collaboration and trading partner environment.

FIG. 2 shows a process flow diagram of a method of securing information in a design collaboration and trading partner environment.

### DETAILED DESCRIPTION OF THE PREFERRED EMBODIMENT

In the following description, a preferred embodiment of the invention is described with regard to preferred process steps and data structures. Those skilled in the art would recognize after perusal of this application that embodiments of the invention can be implemented using one or more general purpose processors or special purpose processors or other circuits adapted to particular process steps and data structures described herein, and that implementation of the process steps and data structures described herein would not require undue experimentation or further invention.

Lexicography

The following terms refer or relate to aspects of the invention as described below. The descriptions of general meanings of these terms are not intended to be limiting, only illustrative.

Firewall—in general, a system designed to prevent unauthorized access to and from a private network.

Vault—in general, an area within a computer system protected by an access methodology.

As noted above, these descriptions of general meanings of these terms are not intended to be limiting, only illustrative. Other and further applications of the invention, including extensions of these terms and concepts, would be clear to those of ordinary skill in the art after perusing this application. These other and further applications are part of the scope and spirit of the invention, and would be clear to those of ordinary skill in the art, without further invention or undue experimentation.

System Elements

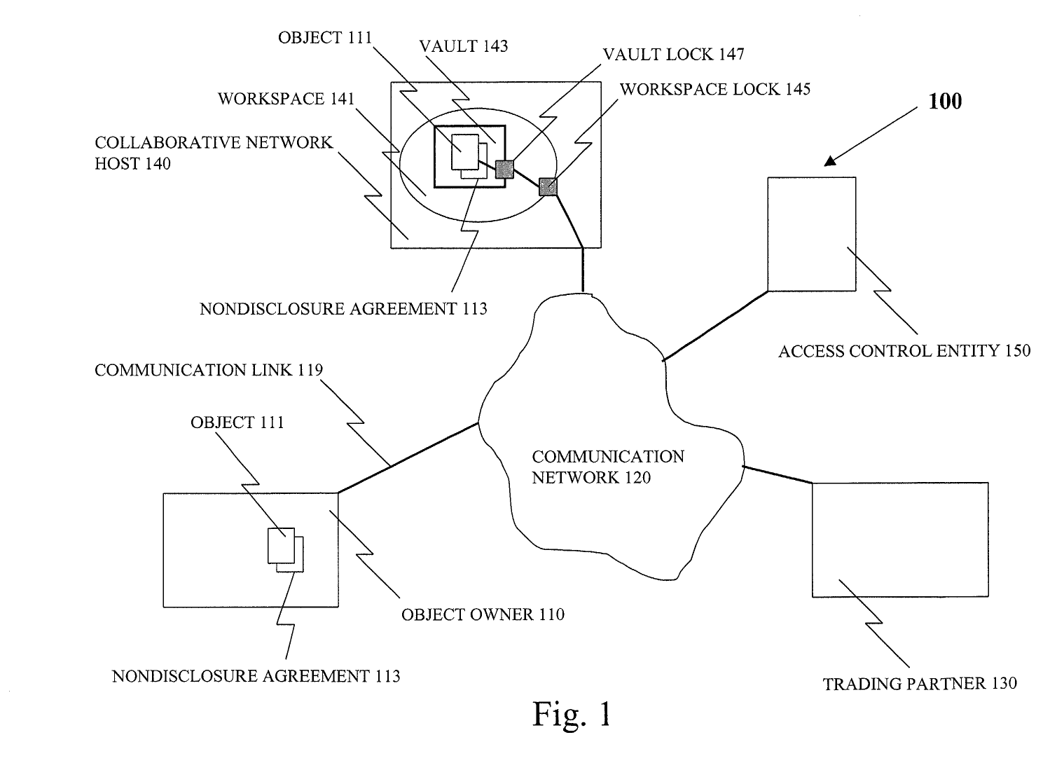

FIG. 1 shows a block diagram of a system capable of securing information in a design collaboration and trading partner environment.

A system 100 includes an object owner 110, a communication network 120, a trading partner 130, a collaborative network host 140, and an access control entity (ACE) 150.

The object owner 110 includes a processor, a main memory, and software for executing instructions (not shown, but understood by one skilled in the art). This software preferably includes software in the form of a browser and plug-in for communicating with the trading partner 130, the collaborative network host 140, and the ACE 150.

The communication network 120 includes at least a portion of a communication network, such as a LAN, a WAN, the Internet, an intranet, an extranet, a virtual private network, a virtual switched network, or some combination thereof. In a preferred embodiment, the communication network 120 includes a packet switched network such as the Internet, as well as (in addition to or instead of) the communication networks just noted, or any other set of communication networks that enable the elements described herein to perform the functions described herein.

The communication link 119 operates to couple the object owner 110 to the communications network 120. Similarly, the communication link 119 operates to couple the trading partner 130, collaborative network host 140, and ACE 150 to the communication network 120.

The trading partner 130 includes a processor, a main memory, and software for executing instructions (not shown, but understood by one skilled in the art). This software preferably includes software in the form of a browser and plug-in for communicating with the object owner 110, the collaborative network host 140, and ACE 150.

The collaborative network host 140 includes a processor, a main memory, software for executing instructions (not shown, but understood by one skilled in the art), and at least one workspace 141. The workspace 141 includes a workspace lock 145, a vault 143, and a vault lock 147. The workspace lock 145 controls access to the workspace 141 and the vault lock 147 controls access to the vault 143.

The workspace lock 145, in contrast to the vault lock 147, controls access to a less secure area within the collaborative network host 140. Generally, the workspace 141 may be accessible on a regular basis by many trading partners 130 who have already received authorization. In a preferred embodiment, the collaborative network host 140 grants keys to the workspace lock 145, as the information disposed in the workspace is generally less sensitive. In a preferred embodiment, these keys include expiration dates, so that a trading partner will be required to renew his access privileges after his key to the workspace lock 145 expires. The workspace 141 differs from the vault 143, which is an more secure area within the collaborative network host 140 that is only accessible if specific conditions are met.

The workspace 141 exists to service the general needs of a specified group of trading partners 130. The vault 143 exists to service the needs of specific trading partners 130 within the specified group.

The ACE 150 includes a processor, a main memory and software for executing instructions (not shown, but understood by one skilled in the art). The software preferably includes instructions for operating the ACE 150 in accordance with the invention and explained further herein. In a preferred embodiment, the ACE 150 includes an Application Service Provider. In alternative embodiments the ACE 150 may be part of the object owner 110 or the collaborative network host 140.

An object 111 includes electronic data represents some aspect of a collaborative design project such as potential product designs, unique product specifications, trade secrets or data concerning other collaborative endeavors that the object owner 110 wishes to limit access to. In a preferred embodiment, the object 111 is in the form of an electronic computer file (for example, a word processing document or a media file). In alternative embodiments the object 111 may be generated electronic data not previously in a file format.

System Operation

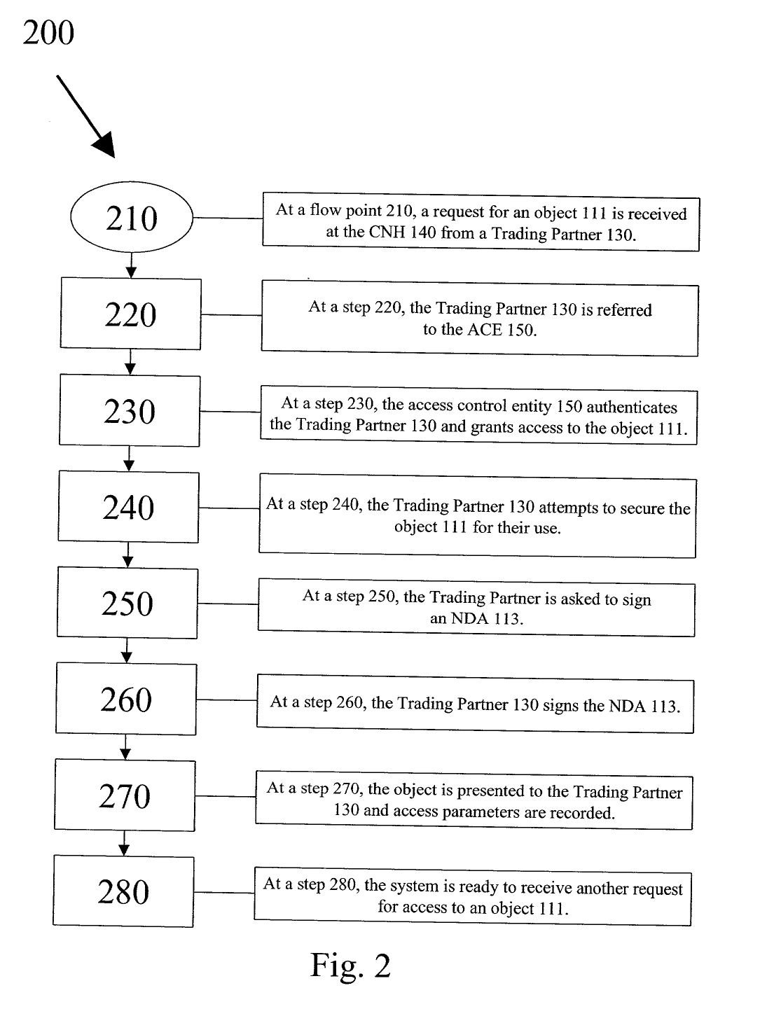

FIG. 2 shows a process flow diagram of a method of securing information in a design collaboration and trading partner environment.

A method 200 described herein is performed by elements of the system 100. Although the method 200 is described serially, the steps of the method 200 can be performed by separate elements in conjunction or in parallel, whether asynchronously, in a pipelined manner, or otherwise. There is no particular requirement that the method 200 be performed in the same order in which this description lists the steps, except were so indicated.

At a flow point 210, a request for an object 111 has been received from the trading partner 130 at the collaborative network host 140. The request for the object 111 includes a request for access to the workspace 141 and vault 143 where the object 111 is stored.

The workspace lock 145 protects access to the workspace 141. In a preferred embodiment, the collaborative network host 140 may grant access to the workspace 141, as this area generally contains data that is less sensitive. In alternative embodiments, access to the workspace 141 may be controlled by the access control entity 150 in the same manner as access to the vault 143, as further described herein.

At a step 220, the request for access to the object 111 is referred to the ACE 150 as access to the vault 143 is required to access the object 111.

At a step 230, the ACE 150 authenticates the trading partner 130 and grants access to the vault 143. Authentication of the trading partner 130 may be in the form of a password submitted by the trading partner 130, a digital signature, or other method of authentication. An access log is updated to record that the trading partner 130 was given access to the vault 143. To open the vault 143 for the trading partner 130, the ACE 150 may set a bit that causes the vault lock 147 to be removed specifically for the trading partner 130.

At a step 240, the trading partner 130 attempts to secure the object 111 for their use as they now have access to the vault 143.

At an (optional) step 250, the trading partner 130 is prompted to sign a nondisclosure agreement 113 before final access to the object 111 is granted. Signing of the nondisclosure agreement 113 may be in many forms. In a preferred embodiment, the nondisclosure agreement 113 is in a click-through form. By clicking an icon, entering appropriate text, or otherwise indicating agreement, the trading partner 130 agrees to the terms listed in the form. In some cases the individual at the trading partner 130 may need to seek a higher authority within the trading partner 130 to sign the nondisclosure agreement 113. In this case, the electronic nature of the nondisclosure agreement 113 allows it to be passed to the higher authority and then back to the ACE 150 once it has been signed. This step is optional.

In a first alternative embodiment of the invention, the trading partner 130 may be prompted for other actions upon attempting to secure the object 111. These actions include but are not limited to; entering one or more codes, using a biometrics device to further authenticate identity, or answering questions.

In a second alternative embodiment of the invention, provisions for negotiating the terms of the nondisclosure agreement 113 may be provided. Thus, if a trading partner 130 finds the nondisclosure agreement 113 to be excessively burdensome, they can attempt to negotiate a less strict agreement that they are willing to sign.

At a step 260, the trading partner 130 signs the nondisclosure agreement 113, or has it signed by the appropriate authority.

At a step 270, the object 111 is presented to the trading partner 130. Additional logs pertaining to access of the object 111 may be recorded at this time. These logs would contain all relevant information relating to the object 111 accessed, including but not limited to; the name of the trading partner 130 (and of the individual at the trading partner 130) making the access, identification of the object 111 accessed, date and time of access, and the name of the individual signing the nondisclosure agreement 113. The logs may be made available to the object owner 110.

At a step 280, the system is ready to receive another request from a trading partner 130 for access to an object 11.

Generality of the Invention

The invention has applicability and generality to other aspects of data security and access thereof.

Alternative Embodiments

Although preferred embodiments are disclosed herein, many variations are possible which remain within the concept, scope, and spirit of the invention, and these variations would become clear to those skilled in the art after perusal of this application.

1. A method for controlling access to sensitive information, including
storing an object securely at an object storage location logically remote from the location of the owner of said object;
receiving a request for access to said object from a requester;
authenticating said requestor at a location logically remote from the location where said object is stored; and
granting access to said object.

2. The method of claim 1, wherein said storing further includes
placing said object in an electronic vault; and
placing said vault in a workspace

3. The method of claim 2, wherein said electronic vault is a secure area within a computer system and access is limited only to those authorized.

4. The method of claim 2, wherein said workspace is a secure area within a computer system limiting access to only those authorized.

5. The method of claim 1, wherein said receiving includes an attempt by said requestor to access said object, wherein said attempt causes said requester to be redirected to an access control entity.

6. The method of claim 1, wherein said authenticating further includes
transferring authentication control to an access control entity;
determining the authentication status of said requestor;
obtaining a confidentiality agreement from said requester; and
providing said status to said object storage location.

7. The method of claim 6, wherein said access control entity is logically remote from said object storage location.

8. The method of claim 6, wherein said access control entity controls access to said object storage location.

9. The method of claim 6, wherein said transferring includes opening a communications path from said access control entity to said requester.

10. The method of claim 6, wherein said determining includes said requestor proving their identity to said access control entity in a previously agreed manner.

11. The method of claim 6, wherein said obtaining includes said requestor agreeing to the terms of a nondisclosure agreement before access to said object is granted.

12. The method of claim 11, wherein said nondisclosure agreement is executed by someone other than said requestor at the request of said requestor through an electronic interchange.

13. The method of claim 6, wherein said providing includes recording a data log relating to the access requested by said requester.

14. The method of claim 1, wherein said granting includes unlocking access to a workspace.

15. The method of 14, wherein said granting further includes unlocking access to a vault.

16. The method of claim 15, wherein said granting further includes recording data relating to the access granted to said requester.

17. An apparatus for controlling access to sensitive information, including
means for storing an object securely at an object storage location logically remote from the location of the owner of said object;
means for receiving a request for access to said object from a requestor;
means for authenticating said requestor at a location logically remote from the location where said object is stored; and
means for granting access to said object.

18. The apparatus of claim 17, wherein said means for storing further includes
means for placing said object in an electronic vault; and
means for placing said vault in a workspace.

19. The apparatus of claim 18, wherein said electronic vault is a secure area within a computer system limiting access to only those authorized.

20. The apparatus of claim 18, wherein said workspace is a secure area within a computer system limiting access to only those authorized.

21. The apparatus of claim 17, wherein said means for receiving includes means for redirecting said requestor to an access control entity upon attempting to access said object.

22. The apparatus of claim 17, wherein said means for authenticating further includes
means for transferring authentication control to an access control entity;
means for determining the authentication status of said requestor;
means for obtaining a confidentiality agreement from said requester; and
means for providing said status to said object storage location.

23. The apparatus of claim 22, wherein said access control entity is logically remote from said object storage location.

24. The apparatus of claim 22, wherein said access control entity includes means for controlling access to said object storage location.

25. The apparatus of claim 22, wherein said means for transferring includes means for opening a communications path from said access control entity to said requestor.

26. The apparatus of claim 22, wherein said means for determining includes means for said requester proving their identity to said access control entity in a previously agreed manner.

27. The apparatus of claim 22, wherein said means for obtaining includes means for said requestor agreeing to the terms of a nondisclosure agreement before access to said object is granted.

28. The apparatus of claim 27, wherein said nondisclosure agreement is executed by someone other than said requester at the request of said requestor through an electronic interchange.

29. The apparatus of claim 22, wherein said means for providing includes means for recording a data log detailing the access requested by said requestor.

30. The apparatus of claim 17, wherein said means for granting includes means for unlocking access to a workspace.

31. The apparatus of 30, wherein said means for granting further includes means for unlocking access to a vault.

32. The apparatus of claim 31, wherein said means for granting further includes means for recording data relating to the access granted to said requestor.
